(19) United States
(12) Patent Application Publication
(10) Pub. No.: US 2013/0097182 A1
(43) Pub. Date: Apr. 18, 2013

(54) Method for calculating distances between users in a social graph

(71) Applicant: Zhijiang He, Sunnyvale, CA (US)

(72) Inventor: Zhijiang He, Sunnyvale, CA (US)

(73) Assignee: ZHIJIANG HE, SUNNYVALE, CA (US)

(21) Appl. No.: 13/317,270

(22) Filed: Oct. 13, 2011

(51) Int. Cl. G06F 17/30

(52) U.S. Cl. 707/748; 707/E17.014

(57) ABSTRACT

The present invention discloses a method for calculating distances between users in a social graph. The relations in the social graph are assigned weighting factors. The distances between two users are calculated from the weighted relations on the paths connecting the two users. In addition, the propagation of relations across neighboring users may be attenuated according to a propagation coefficient. Using the calculated distances, the social search may be performed in the order of non-decreasing distances from the source users. Moreover, clusters may be created from a social graph based on the calculated distances. The search in a dense social graph may be converted to a search in the generated clusters. Therefore the performance of social search across neighbors is improved.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### US PATENT REFERENCES

Not Applicable

### OTHER REFERENCES

“Six degrees of separation”, http://en.wikipedia.org/wiki/Six_degrees_of_separation
“Cluster analysis”, http://en.wikipedia.org/wiki/Cluster_analysis
“Iterative deepening depth-first search”, http://en.wikipedia.org/wiki/Iterative_deepening_depth-first_search

### FIELD OF THE INVENTION

The present invention relates generally to techniques of searching in a social graph. More specifically, it relates to calculating distances between users in a social graph.

### BACKGROUND OF THE INVENTION

The popularity of social networking in recent years has established large databases of social connections, i.e. social graphs. A social graph describes a set of relations between users of a social networking service. Specifically, a node in a social graph represents a user of a social networking service. An edge in a social graph connects two nodes and indicates that a social relation exists between the two corresponding users.

There are a variety of relations between human entities. Accordingly, a variety of social graphs exist to describe various relations. For instance, the social graphs of Facebook and Google+ represent friendship between users. The social graph of LinkedIn represents professional links between users. The social graph of Twitter represents following relations between users.

A social search tries to find matched users in a social graph according to predefined search criteria such as textual matching of users' profile etc. It starts from one or more source users. The source users' neighbors in a social graph are searched first. Then it continuously expands the scope of the search across neighbors until certain stop conditions are satisfied.

For instance, when a recruiter performs a search in a professional social graph for potential job candidates, he/she would like to find candidates with professional links to his/her past hirings. The logic behind is that a recruiter may have more trust in candidates with professional links to his/her past hirings than unrelated candidates. In another word, the goal of a social search is to find a list of best matches in the context of relation.

Currently, social searches use breath first or similar approaches to search beyond the neighboring users in a social graph. Unfortunately, a user in a social graph may have hundreds of connections. The large branching factor may dramatically increase the computation cost.

To handle the large branching factor problem, the users in a social graph may be sorted in terms of closeness of relations with respect to the source users. Users with closer relation to the source users are searched first. Moreover, the scope of the search may also be constrained.

To this end, a method is required to calculate users' distances from the source users. Users with shorter distances from the source users are searched first. Furthermore, the scope of a search may also be conveniently defined using the calculated distances.

More importantly, based on the calculated distances, clusters may be created from a social graph. A search in a social graph is converted to a search in the clusters. For instance, if density based clustering is used, a search may be performed within the clusters that source users belong to. Alternatively, if a hierarchy is created, a search may start from the smallest cluster that the source users belong to and may move up the hierarchy if necessary.

Accordingly, it is an object of this invention to provide a method for calculating distances between users beyond neighbors to facilitate social search. Moreover, clusters based on the calculated distances may be created. Therefore, a search in a social graph is converted to a search in the generated clusters.

### BRIEF SUMMARY OF THE INVENTION

The present invention provides a method for calculating distances between users in a social graph. The relations in a social graph may have distinct importance. Therefore, weighting factors are assigned to the relations in a social graph. The distances between users are calculated from the weighted relations on the paths connecting the two users. If two users have no path connecting them, then the distance between them is infinity. According to the calculated distances from one or more source users, search in a social graph may be performed in the order of non-decreasing distances from the source users. Moreover, using the calculated distances, clusters may be created from a social graph to improve the performance of a social search.

A person in real life may know hundreds of people. Nonetheless, he/she may have close relations with only very few of them. His/her relations with the remaining friends may be relatively looser. In other words, a person's friends are tiered. This is also true for the relations of a user in social networking. This phenomenon serves as the theoretical foundation of calculating distances between users in a social graph. If two users have close direct/indirect relation, the distance between the two users is also small.

A search in a social graph may be performed in the order of non-decreasing distances from the source users. The search scope may be constrained with a predetermined cutoff distance. Users with larger distances from the source users than the predetermined cutoff distance will not be searched.

Moreover, clusters may be created to improve search in a social graph. The clusters may be created using density based approaches. The clusters may also be created using hierarchical approaches.

### BRIEF DESCRIPTION OF THE DRAWINGS

FIG. 1 shows a diagram for a 3-user social graph with weighting factors according to the invention.

FIG. 2 shows a diagram for a 3-user social graph with weighting factors, path distances and distances according to the invention.

FIG. 3 shows a social graph in which the connecting path via a third user has the shortest distance between two users according to the invention.

FIG. 4 shows that the propagated relations attenuate across neighbors according to the invention.

FIG. 5 shows a flow chart of one embodiment of the invention.

### DETAILED DESCRIPTION OF THE INVENTION

In the following description, numerous specific details are set forth in order to provide a thorough understanding of the invention. It will be apparent to one skilled in the art, however, that the present invention may be practiced without these specific details. Accordingly, the following embodiments of the invention are set forth without any loss of generality to, and without imposing limitations upon, the claimed invention.

Given an undirected social graph G(V, E), V represents the set of nodes in G and E represents the set of edges connecting the nodes in V. Essentially, V is the set of users in a social networking service and E describes the relations between the users. For instance, if there is a relation between user vᵢ and vⱼ, a nonzero eᵢⱼ represents the relation between them. Each user vᵢ is assigned an importance rank rᵢ. In one embodiment of the invention, an importance rank may be determined from a user' profile, join time, last access time, activities, locations, interests and preferences.

Part of the value of a social graph is the closeness of relations it conveys. Although a user may have hundreds of connections, the connections may carry disparate levels of closeness. In one embodiment of the present invention, family relation carries high level of trust. In another embodiment of the invention, if there are more communications between two users, the relation between them may be closer as well.

To model the closeness of the relations between users, the present invention assigns weighting factors to the relations in a graph. From the perspective of probability, a weighting factor can be interpreted as a predetermined probability of selecting the next user from the current user's neighbors to traverse when searching a social graph. As the next user to visit is always one of vᵢ's neighbors, it follows that

$${\sum }_{j} {w}_{ij} = 1.$$

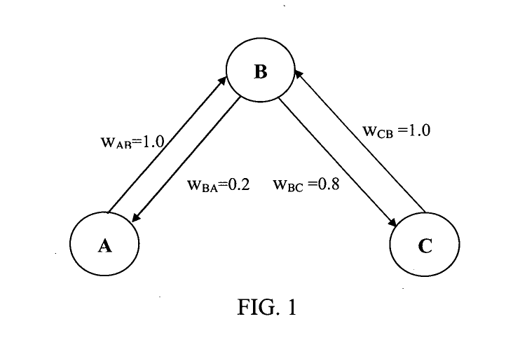

One embodiment of the present invention is shown in FIG. 1. There are three users A, B, C in FIG. 1. User B has relations with both A and C. Nonetheless, both A and C have relation with only B respectively. Both w_{AB} and w_{CB} are 1.0, while w_{BA} and W_{BC} are 0.2 and 0.8 respectively.

Apparently, wᵢⱼ and wⱼᵢ are not necessarily equal. For this reason, the original undirected G(V, E) is converted to a directed graph G′(V, W′), where each edge eᵢⱼ/eⱼᵢ in G is split into two directed edges wᵢⱼ and in G′.

wᵢⱼ may be obtained from the closeness of relation from user vᵢ to vⱼ. In one embodiment of the present invention, it may be derived from the communications between user vᵢ and vⱼ. In another embodiment of the present invention, it may be dependent on the users' importance rank rᵢ and rⱼ, which may be calculated from users' profiles, join times, last access times, activities, locations, interests and preferences.

In one embodiment of the present invention, if there is no relation closeness information available, the weighting factor of a relation may be calculated as

wᵢⱼ=1/n

where n is the number of relations vᵢ has.

There may be a number of paths from a first user to a second user. Assuming path distance pdᵢⱼₖ is the distance of a kth path from user vᵢ to vⱼ, The distance dᵢⱼ from user vᵢ to vⱼ is defined as

$${d}_{ij} = {min}_{k} {pd}_{ijk}$$

which is the minimum path distance from vᵢ to vⱼ.

Similar to the asymmetry of weighting factors, distances are asymmetric as well. Specifically, distance dᵢⱼ may not be equal to dⱼᵢ.

The path distance should be inverse to the weighting factors on the path. Specifically, larger weighting factors, i.e. higher probability, means shorter distance between the users. Moreover, the probability of visiting user vⱼ from vᵢ following a path should be the multiplication of the probabilities of edges on the path. Therefore, in one embodiment of the present invention, the path distance pdᵢⱼₖ may be defined as

pdᵢⱼₖ=1/Πwₘₙ

where wₘₙ is the weighting factor for a relation from vₘ to vₙ on path k.

The propagation of relation across neighboring users should be an attenuating process. A propagation coefficient α is defined and should be in the interval of [0,1]. Accordingly, in one embodiment of the present invention, the path distance pdᵢⱼₖ may be defined as

pdᵢⱼₖ=1/Πw′ₘₙ

where w′ₘₙ is equal to a*wₘₙ except for the last edge in the path. The w′ₘₙ for the last edge in the path is wₘₙ.

Given the 6 degrees of separation, a recommendation is to select α⁷=ε where ε is the truncation error of the method. For instance, if ε is 0.001, then a would be 0.373.

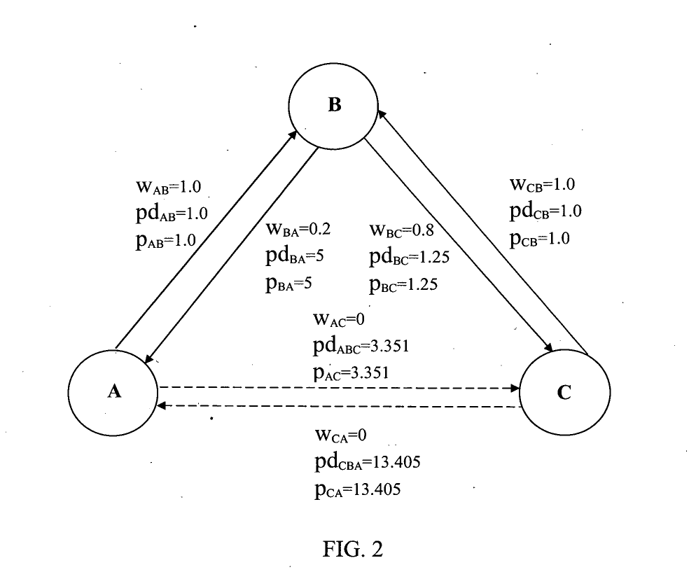

One embodiment of the present invention is FIG. 2. It shows the same social graph as that in FIG. 1. The social graph in FIG. 2 has the same weighting factors as the social graph in FIG. 1. The path distances pd_{AB}, pd_{BA}, pd_{BC}, pd_{CB}, pd_{CA}, pd_{AC} are given in FIG. 2. pd_{AC} is calculated as 1/(1.0*0.373*0.8)=3.351. Similarly, pd_{CA} is calculated as 1/(1.0*0.373*0.2)=13.405. In this example, the path distances are the same as distances between users.

The embodiment of the invention in FIG. 2 apparently demonstrates the distinction of the present method from the well-known graph traversal approaches for social search. In common graph traversal approaches, the distances between two users are calculated as the minimum number of relations connecting the two users in a social graph. However, the present method is more complex and subtle. In one embodiment of the present invention, it is determined as the minimum path distance, which is the reciprocal of the multiplication of weighting factors of relations on the minimum distance path.

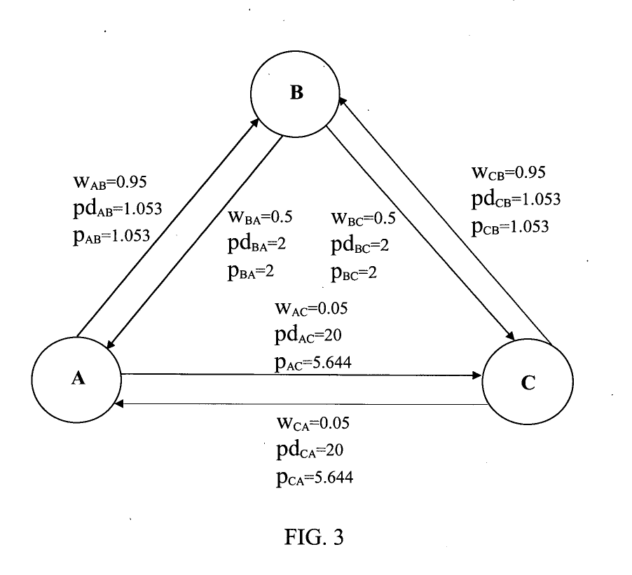

The metric of social distance may be count-intuitive and distinct from the normal Euclidean distance etc. The shortest distance between two users may not be the path distance of the direct connection between the two users. FIG. 3 shows an example. The path distance of the direct connection between A and C is 20. However, the distance from A to C via B is 1/(0.95*0.373*0.5)=5.644. Conceptually, this is possible in real life. Two people A and C may not have close relation between them. Nonetheless, A and C may share a very close common friend B. The communication between A and C via a third person B may be more effective than the direct communication between A and C.

Propagating relations across the social graph may appear to be a daunting computational task. Fortunately, with the propagation coefficient α in the interval of [0, 1], for instance, 0.373, the computational complexity is reduced to a large extent. Moreover, given the large number of connections for each user, most of the connections' weighting factors are much smaller than 1, therefore, only very few weighting factors of a user's relations will be propagated across neighbors.

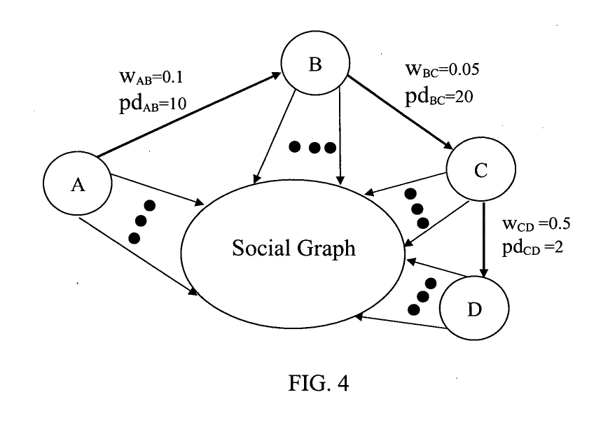

FIG. 4 shows an example. For simplicity, not all relations are shown. User A, B, C and D may have hundreds of relations. w_{AB}, w_{BC} and w_{CC} are 0.1, 0.05 and 0.5 respectively. In this case, if truncation error E is 0.001, the multiplication of weighting factors from A to C via B is (0.1*0.373)*0.05=0.002, therefore, the path distance from A to C via B is 536.193. However, the multiplication of weighting factors from A to D via B and C is (((0.1*0.373)*0.05)*0.373)*0.5=0.0003<0.001, which means that the path distance from A to D via B and C is infinity according to truncation error 0.001.

To calculate path distances from a source user in a social graph, only users within the perimeter of a predetermined depth from the source user need to be considered. If a user is outside the perimeter of the source user, the propagated weighting factors would be 0 according to truncation error E and its distance from the source user would be regarded as infinity.

In one embodiment of the present invention, iterative deepening depth first traversal may be applied on a source user. The depth for the iterative deepening traversal is a predetermined depth, for instance 6. If the multiplication of weighting factors on the path is smaller than a predefined truncation error E, then the propagation along this path is stopped. More specifically, the neighbors of a source user are visited in the order of non-decreasing weighting factors. If the traversal along a relation with a larger weighting factor stops, then traversal along other relations with smaller weighting factors stops as well.

When the distances between users are available, search in a social graph may be conducted from source users in the non-decreasing order of distances from the source users. Users with shorter distances from the source users are searched first. The search may be stopped if the distances from the source users are larger than a predetermined cutoff distance.

Moreover, based on the calculated distances, clusters may be created from a social graph to enhance the performance of social search. Various clustering techniques may be used. In one embodiment of the present invention, density based clustering may be used. In another embodiment of the present invention, the hierarchical approaches may be used. The hierarchical clustering may be created in various ways. In one embodiment of the present invention, a hierarchy may be created in an agglomerative way. In another embodiment of the present invention, a hierarchy may be created in a divisive way.

Generally, distance metrics used in clustering algorithms are symmetric. However, distances between two users in a social graph may be asymmetric. The asymmetry of social distances should be considered during the clustering process. In one embodiment of the present invention, two users with balanced two-way distances may be given some priority in the process of clustering.

Suppose the distances between user A and B are d_{AB} and d_{BA}. During the clustering process, both min(d_{AB},d_{BA}) and the variation between d_{AB} and d_{BA} may be considered. If d_{AB}/d_{BA} is close to 1, the relation between A and B is balanced. In one embodiment of the present invention, the link distance in clustering LD_{AB} may be defined as:

LD_{AB}=min(d_{AB},d_{BA})*f((d_{AB},d_{BA})

where f(d_{AB}, d_{BA}) is either 1.0 or 1.5. If d_{AB}/d_{BA} is within the interval of [0.5, 2], f(d_{AB}, d_{BA}) is 1.0. If d_{AB}/d_{BA} is outside the interval of [0.5, 2], f(d_{AB}, d_{BA}) is 1.5.

In one embodiment of the present invention, the linkage criteria used in the hierarchical clustering process may be defined as the minimum distance between each elements of each cluster, i.e. single linkage clustering.

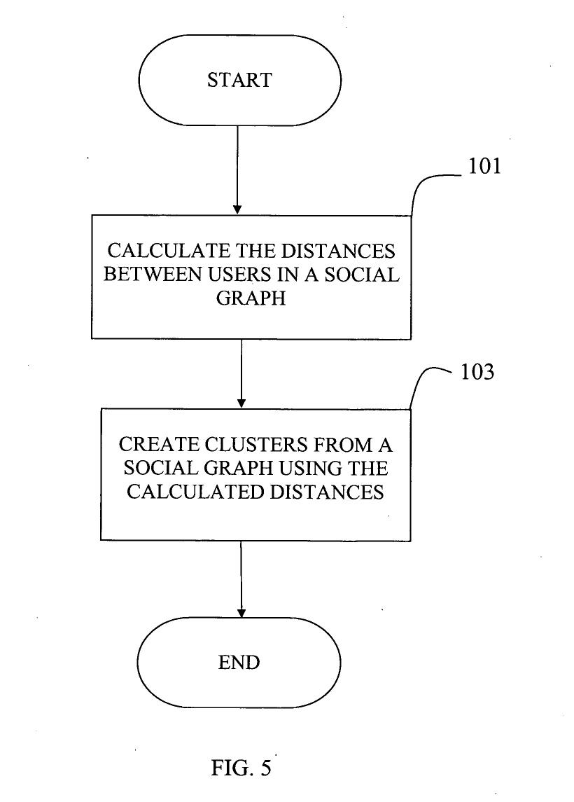

FIG. 5 shows a flow chart of one embodiment of the implementation of the present invention. At step 101, distances between users in a social graph are calculated. At step 103, clusters are created using the distances calculated at step 101.

After the clusters are created, a social search may be converted to a search in the generated clusters. For instance, a recruiter wants to find a list of qualified candidates in a professional graph. If density based clustering is used, the search will be conducted in the cluster that the recruiter belongs to. If a clustering hierarchy is created, the search will start from the bottom of the hierarchy and will go up the hierarchy until certain stop criteria are met. This search will provide a list of qualified candidates in the order of non-decreasing social distances.

When presenting the search results, the matched users' information/URL links may be listed. The distances from the source users to the matched users may be displayed. Moreover, the paths connecting the source users to the matched users with the minimum distances may also be displayed.

The present invention has been disclosed and described with respect to the herein disclosed embodiments. However, these embodiments should be considered in all respects as illustrative and not restrictive. Other forms of the present invention could be made within the spirit and scope of the invention.

What is claimed is:

1. A method to calculate distances between users in a social graph, comprising:
obtaining information of a plurality of social networking service users, at least some of the users having relations with other users;
assigning a weighting factor to each relation from a first user to a second user;
calculating the distance from a first user to a second other, the distance being dependent on the weighted relations on the paths connecting the first user to the second user, and
processing the social networking service users according to their calculated distances.

2. The method of claim 1, wherein the assigning a weighting factor includes:
identifying a weighting factor for a relation from a first user to a second user and a weighting factor for the relation from the second user to the first user, the two weighting factors being not equal.

3. The method of claim 1, wherein the calculating the distance includes:
determining the distance from a first user to a second user and the distance from the second user to the first user, the two distances being not equal.

4. The method of claim 1, wherein the assigning a weighting factor includes:
identifying a weighting factor for each relation from a first user to a second user, the weighting factor being dependent on the number of relations that the first user has.

5. The method of claim 1, wherein the assigning a weighting factor includes:
identifying a weighting factor for each relation from a first user to a second user, the weighting factor being dependent on the closeness of relation between the two users.

6. The method of claim 1, wherein the assigning a weighting factor includes:
identifying a weighting factor for each relation from a first user to a second user, the weighting factor being dependent on the communications between the two users.

7. The method of claim 1, wherein the assigning a weighting factor includes:
calculating an importance rank for each user, and identifying a weighting factor for each relation from a first user to a second user, the weighting factor being dependent on the ranks of the two users.

8. The method of claim 7, wherein the calculating an importance rank includes:
determining an importance rank for each user, the rank being dependent on the user' profile, join time, last access time, activities, locations, interests and preferences.

9. The method of claim 1, wherein the assigning a weighting factor includes:
identifying a weighting factor for each relation from a first user to a second user based on the estimation of a probability that the second user will be visited from the first user in social search.

10. The method of claim 1, wherein the calculating the distance includes:
computing the distance of a path connecting a first user to a second user based on the weighted relations on the path, and
determining the distance from a first user to a second user based on the distances of the paths connecting the first user to the second user.

11. The method of claim 10, wherein the determining the distance includes:
calculating the distance from a first user to a second user based on the minimum path distance from the first user to the second user.

12. The method of claim 10, wherein the computing the distance of a path includes:
calculating the distance of a path from a first user to a second user based on the reciprocal of the multiplication of the weighting factors of relations on the path.

13. The method of claim 10, wherein the computing the distance of a path includes:
calculating the distance of a path from a first user to a second user based on the reciprocal of the multiplication of the weighting factors of relations on the path, the relation's weighting factors being attenuated by a propagation coefficient.

14. The method of claim 1, wherein the processing the social networking service users includes:
displaying the users as a directory listing.

15. The method of claim 1, further comprising:
searching the users based on predefined criteria.

16. The method of claim 1, wherein the processing the social networking service users includes:
creating clusters based on the calculated distances between users;
searching the generated clusters based on predefined criteria, and
displaying the search results as a directory listing.

17. The method of claim 16, wherein the creating clusters includes:
establishing a hierarchy of users using the calculated distances between users.

18. The method of claim 17, wherein the establishing a hierarchy includes:
establishing a hierarchy using the calculated distances between users in an agglomerative way, starting with every user as a cluster and merging pairs of clusters recursively when moving up the hierarchy.

19. The method of claim 17, wherein the establishing a hierarchy includes:
establishing a hierarchy using the calculated distances between users in a top-down manner, starting with all users in a cluster and dividing the clusters recursively when moving down the hierarchy.

20. The method of claim 17, wherein the establishing a hierarchy includes:
determining linkage criteria between two sets of users based on the distances between users.

21. The method of claim 17, wherein the establishing a hierarchy includes:
determining linkage criteria based on the minimum distances between each pair of users from two sets of users.

22. The method of claim 20, wherein the determining linkage criteria includes:
identifying linkage criteria based on both the distances between users and the distance asymmetry between users.

23. The method of claim 16, wherein the creating clusters includes:
establishing density based clusters using the calculated distances.

24. The method of claim 14, wherein the displaying the users includes:
displaying the URL links to the users, and
displaying the annotation representing the minimum distances from the source users to the matched users.

25. The method of claim 24, wherein the annotation includes:
the paths connecting the source users to the matched users with the minimum distances.
